(19) United States
(12) Patent Application Publication
(10) Pub. No.: US 2008/0054533 A1
(43) Pub. Date: Mar. 6, 2008

(54) Micro-Filer and Injection Molding Machine Using the Same and Injection Molding Method for the Same

(75) Inventor: Myong Deok Kim, Gyeongsangnam-do (KR)

Correspondence Address: MCKENNA LONG & ALDRIDGE LLP, 1900 K STREET, NW, WASHINGTON, DC, 20006, US

(73) Assignee: LG ELECTRONICS, INC., YONGDUNGPO-GU (KR)

(21) Appl. No.: 10/554,868

(22) PCT Filed: Jul. 20, 2005
(86) PCT No.: PCT/KR05/02331

§ 371 Date: Apr. 5, 2007

(30) Foreign Application Priority Data
Jul. 21, 2004 (KR) P 2004-56836

(51) Int. Cl. B29C 33/16

(52) U.S. Cl. 264/478; 425/3; 428/403

(57) ABSTRACT

A micro-filer and an injection molding machine using the micro-filer and an injection molding method are disclosed. The micro-filer and an injection molding machine using the micro-filer and an injection molding method includes a micro-filer; an injection molding machine comprising metal molds in which micro-filers are distributed in resin and the cavity is formed to have the resin injected, thereby injection molding a product and a magnetic force generation unit for generating a magnetic force strong enough that the magnetic force is applied to the micro-filers distributed within the resin and the micro-filers are distributed concentratedly at one side of the injection molded product of resin; and a method of injection molding comprising a resin injection step in which resin having magnetic micro-filers distributed therein is injected, a magnetization step in which a magnetic force is generated in one side direction of metal molds and applied to the micro-filers within the resin for concentratedly distributing the micro-filers on one side of the resin, a cooling step in which the resin is cooled and hardened in the metal molds, and an extraction step in which the hardened resin is extracted from the metal molds.

### TECHNICAL FIELD

The present invention relates to an injection molding of resin, and more particularly, to a micro-filer and an injection molding machine using the micro-filer and an injection molding method capable of accomplishing even a coating in one process when injection molding products of resin such as plastic.

### BACKGROUND ART

Generally, an injection molding is suitable for mass production of components having a complex shape. Therefore, such an injection molding has been applied to the extent of exteriors of electric home appliances and components etc. Also, the exteriors of electric appliances and the components are injection molded with plastic due to a facilitation of the manufacturing and a low cost of materials.

The examples of such a metal mold applied to a plastic injection molding machine are illustrated in FIGS. 1 and 2 as sectional views.

FIG. 1 illustrates a sectional view when the metal molds of the plastic injection molding are closed and FIG. 2 illustrates a sectional view when the metal molds of the plastic injection molding are opened, that is, when an injection molded product is extracted.

As shown in the drawings, the general plastic injection molding machine comprises a fixed metal mold 10 and a moving metal mold 20 movably mounted with respect to the fixed metal mold 10.

A recess part 12 recessed in a shape of which a product is supposed to be manufactured is formed in a center of the fixed metal mold 10.

Also, a core 22 is connected with the moving metal mold 20 corresponding to the fixed metal mold 10 for forming a cavity by means of working together with the recess part 12 of the fixed metal mold 10.

Furthermore, a plurality of ejecting pins 23 is installed in the moving metal mold 20, passing through the core 22, for ejecting and then extracting a molded product in the cavity.

Thus, a fluidized resin through an opening for a resin injection (not shown) is filled in the cavity and then an injection molded product 40 is formed.

Once the resin is filled, the filled resin is cooled for a predetermined time so that it may be hardened and then be formed as an appearance of the injection molded product. Hence, after the fixed metal mold 20 is opened, the resin is separated from the core 22 by the ejection pins 23, thereby the injection molded product 40 being extracted.

A surface of the injection molded product 40 in the above process is colored, after that it is applied to a component of electric home appliances.

FIG. 3 illustrates a flow chart of a coloring process of the related art injection molded product.

The injection molded product 40 extracted form the metal mold may have a dust or oil in the injection molding process may remain on the surface. If the injection molded product 40 is colored on the dust or the oil, the coloring is not performed well, thereby a degreasing and cleaning process being needed for removing the dust or the oil.

Primer is applied to the surface of the injection molded product 40 first, so that the surface may be colored well. The primer is employed to prevent paint applied thereafter from coming off from the surface of the injection molded product 40.

Furthermore, after the primer is applied, paint with a color is applied to the surface of the injection molded product 40.

Hence, a brightner is applied on the colored surface as necessary for not only protecting the colored surface but also giving luster to the colored surface.

However, the related art injection molding and coloring process is so complex to be completed from the injection molding to the coloring that it may cause such problems that manufacture expense is heavy and inferiority rises because inferior products are produced in every process, and may cause low productivity because it takes a long time to manufacture the products.

### DISCLOSURE OF INVENTION

### [Technical Problem]

An object of the present invention devised to solve the problem is to provide a micro-filer and an injection molding machine using the micro-filer, and an injection molding method for it which is enabled to have a simple manufacturing process, low manufacturing expense and high productivity.

### [Technical Solution]

To achieve this object and in accordance with the purpose of the invention as embodied and broadly described herein, the present invention provides a micro-filer in a micro-particle shape mixed with resin to be distributed within the resin.

An anti-rust metal may be plated on a surface of a micro-filer.

Powder paint may be painted on the surface of the micro-filer.

Powder paint may be painted on the surface of the micro-filer.

The micro-filer may be in a spherical shape or an oval shape.

The micro-filer may be less than 50 μm in diameter.

Furthermore, the present invention provides an injection molding machine comprising metal molds in which micro-filers are distributed in resin and the cavity is formed to have the resin injected, thereby injection molding a product; and a magnetic force generation unit for generating a magnetic force strong enough that the magnetic force is applied to the micro-filers distributed within the resin and the micro-filers are distributed concentratedly at one side of the injection molded product of resin.

An anti-rust metal is plated or a colored paint is painted on a surface of the micro-filer.

The micro-filer is less than 50 μm in diameter.

The micro-filer is in a spherical shape or an oval shape.

The magnetic force generated from the magnetic force generation unit is applied in a direction to pull the micro-filers toward an exterior surface of an injection molded product of resin.

Also, the present invention provides a method of injection molding comprising a resin injection step in which resin having magnetic micro-filers distributed therein is injected; a magnetization step in which a magnetic force is generated in one side direction of metal molds and applied to the micro-filers within the resin for concentratedly distributing the micro-filers on one side of the resin; a cooling step in which the resin is cooled and hardened in the metal molds; and an extraction step in which the hardened resin is extracted from the metal molds.

An anti-rust metal is plated or a colored pain is painted on a surface of the micro-filer.

The micro-filer is less than 50 μm in diameter.

The micro-filer is in a spherical shape or an oval shape.

### [Advantageous Effects]

The micro-filer and an injection molding machine using the micro-filer and an injection molding method according to the present invention may have an advantageous effect that from an extraction process to a painting process are performed in one process within metal molds without many steps of processes, thereby making the entire process simple.

Also, the micro-filer and an injection molding machine using the micro-filer and an injection molding method according to the present invention may have another advantageous effect that the entire process is simplified and the inferiority is reduced, thereby enhancing productivity.

### DESCRIPTION OF DRAWINGS

The accompanying drawings, which are included to provide a further understanding of the invention, illustrate embodiments of the invention and together with the description serve to explain the principle of the invention.

In the drawings:

FIG. 1 illustrates a sectional view showing when metal molds of a related art plastic injection molding machine are closed;

FIG. 2 illustrates a sectional view when the metal molds of the related art plastic injection molding machine in FIG. 1 are opened;

FIG. 3 illustrates a flow chart of a coloring process of the related art injection molded product;

FIG. 4 illustrates a perspective view of a micro-filer according to the present invention;

FIG. 5 illustrates a sectional view showing key parts of an injection molding machine according to the present invention;

FIG. 6 illustrates a sectional view showing a sate in that the metal molds in FIG. 5 are magnetized; and

FIG. 7 illustrates a flow chart of an injection molding method according to the present invention.

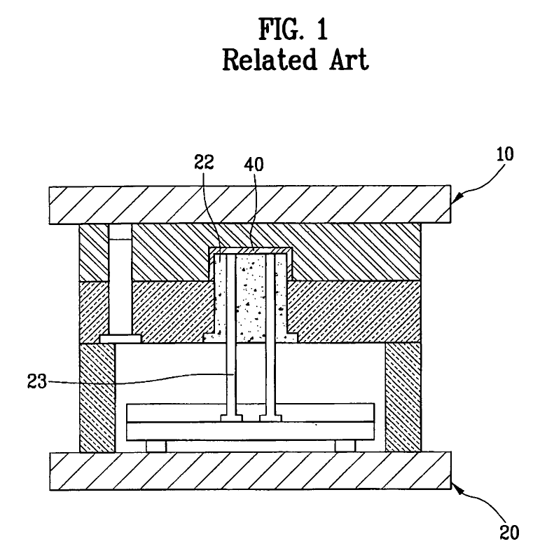

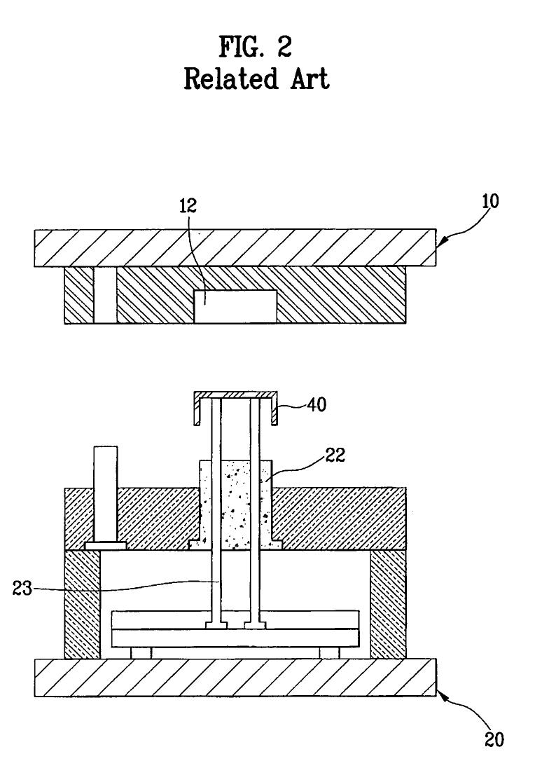

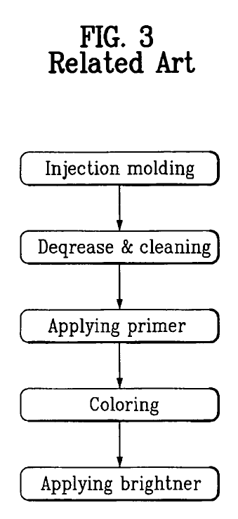

### BEST MODE FOR CARRYING OUT THE INVENTION

Reference will now be made in detail to the preferred embodiments of the present invention, examples of which are illustrated in the accompanying drawings.

The same configuration elements of the present invention as those of the related art micro-filer forming a surface of a resin injection molded product and an injection molding machine and a method thereof will be omitted, referring to the related art.

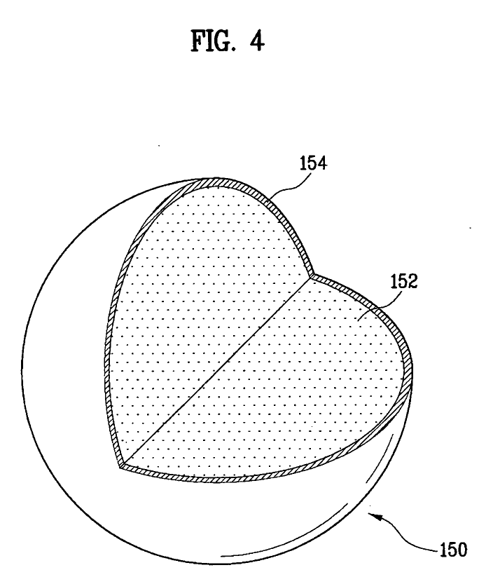

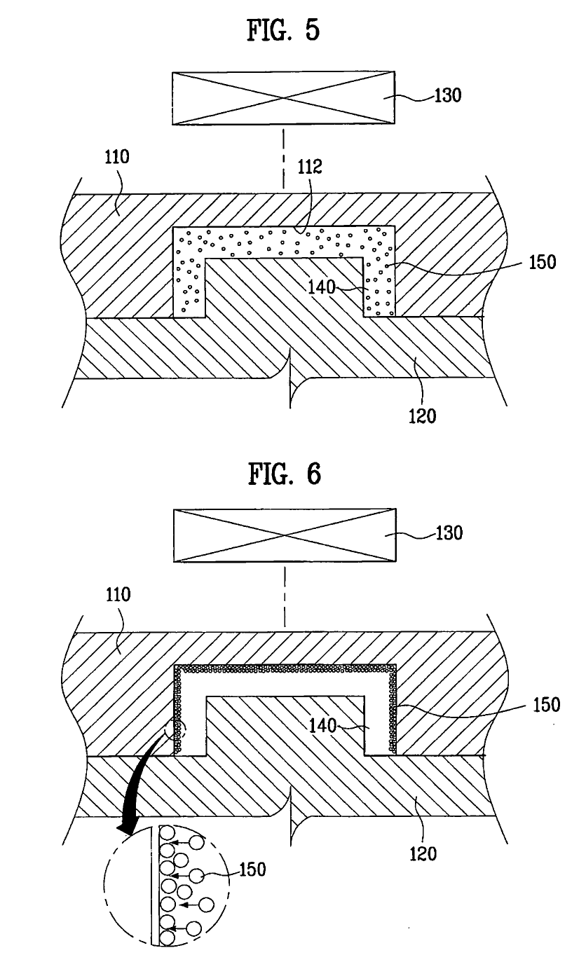

FIG. 4 illustrates a diagram showing a micro-filer which forms a surface of a resin injection molded product according to the present invention. FIGS. 5 and 6 illustrate diagrams showing key parts of the resin injection molded product according to the present invention.

As shown in FIG. 4, a micro-filer 150 for forming the surface of the resin injection molded product according to the present invention has a micro particle shape. Also, the center 152 thereof is made of a magnetic material such as steel and then the micro-filers are mixed with resin 140 penetrated into a cavity 112 in metal molds, thereafter distributed in the resin 140.

Herein, the micro-filer 150 may be formed in a spherical shape or an oval shape having a diameter of less than 50 μm.

An anti-rust metal such as Al, Zn, Cr, Ni may be plated on a surface 154 of the micro-filer 150.

Also, powder painting which uses powder paint for forming both a color and luster may be performed on the surface 154 of the micro-filer 150, and furthermore colored paint may be painted on the surface 154 of the micro-filer 150.

The resin 140 having the micro-filers distributed is fluidized and penetrated in the cavity 112 of the metal molds of the injection molding machine.

As shown in FIG. 5, the injection molding machine which performs injection molding by means of using the resin mixed with the micro-filers may comprises metal molds 110, 120 having a cavity 112 in which a shape of a will-be injection molded product is formed, a magnetic force generation unit 130 which applies a magnetic force to the micro-filers 150 distributed in the resin 140 filled in the cavity 112.

Also, the metal molds 110, 120 may be a fixed metal mold 110 and a moving metal mold 120 as similar as described in the background art.

The magnetic force generation unit 130 made of materials such as an electromagnet is provided for magnetizing any first side of the fixed metal mold 110 and the moving metal mold 120, so that the magnetized metal mold applies magnetism to the micro-filers 150 within the resin 140.

Furthermore, the metal molds 110, 120 which will be magnetized may be made of a ferromagnetic material for utilizing the magnetic force generated from the magnetic force generation unit 130 efficiently.

Since the configuration of the magnetic force generation unit 130 is well-known for any skilled in this art, the detailed description thereof according to the present invention will be omitted.

As shown in FIG. 6, the magnetic force applied to the micro-filers 150 by the metal molds magnetized by means of the magnetic force generation unit 130 operation may be strong enough to pull the micro-filers 150 within fluidized resin 140 toward any one direction and to distribute the micro-filers 150 on a first surface of the injection molded product concentratedly.

An injection molding method of using the micro-filer and the injection molding machine will be described.

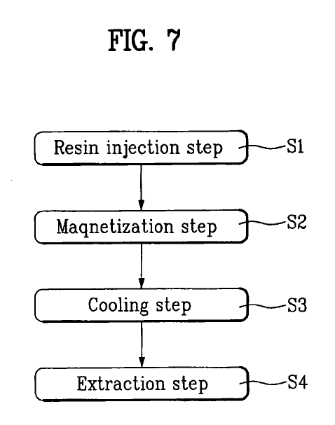

FIG. 7 illustrates a flow chart of an injection molding method according to the present invention.

As shown in FIG. 5, a resin injection step S1 is performed in which resin 140 in a state of fluidity is injected into a cavity 112 in metal molds 110, 120.

In the resin 140, the described micro-filer 150 is mixed.

After the resin injection step S1, a magnetization step S2 is performed in which the metal molds are magnetized by means of using the magnetic force generation unit 130 of the injection molding machine and then the magnetic force is generated in one side direction of the resin 140.

As shown in FIG. 6, according as the magnetic force is generated in the magnetization step S2, the micro-filers 150 may be pulled by the magnetic force generated from the magnetic force generation unit 130 and in succession may be moved toward a direction in which the magnetic force is generated, because the micro-filers 150 distributed in the resin 140 also have magnetism. Therefore, the micro-filers 150 are arranged on a surface of the resin 140.

At this time, the direction in which the micro-filers 150 in the resin 140 are pulled is an exterior surface direction of the injection molded product so that the micro-filers may be distributed on the exterior surface of the injection molded product.

Furthermore, the magnetization step S2 is performed before the resin 140 gets hardened, because the micro-filers 150 can not be moved if the resin 140 is hardened before the micro-filers 150 are moved.

After the magnetization step S2 moving the micro-filers 150, a cooling step S3 is performed in which the resin 140 is cooled and hardened for maintaining a shape of the resin 140.

After the cooling step S3 cooling and hardening the resin 140, an extraction step S4 is performed in which the metal molds 110, 120 are opened and an injection molded product is extracted from the cavity 112 in the metal molds 110, 120.

The injection molded product extracted form the cavity 112 has a color because the colored micro-filers 150 are arranged on the surface of the injection molded product. Since the sizes of the micro-filers 150 are so minute that the injection molded product may have the entirely smooth surface and may have the surface showing kinds of metal plated or, a color and a property of paint painted on the surface of the micro-filer 150.

Accordingly, when varying the kinds of metals plated and paint painted on the surface of the micro-filer 150, it is possible for the injection molded product to have various kinds of surfaces.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

The micro-filer and an injection molding machine using the micro-filer and an injection molding method according to the present invention may have an industrial applicability, because from an extraction process to a painting process are performed in one process within metal molds without many steps of processes, thereby making the entire process simple.

The micro-filer and an injection molding machine using the micro-filer and an injection molding method according to the present invention may have an industrial applicability, because the entire process is simplified and the inferiority is reduced, thereby enhancing productivity.

1. A micro-filer having magnetism in a micro particle shape, which is mixed with resin where an injection molding is performed and distributed within the resin.

2. The micro-filer as claimed in claim 1, wherein an anti-rust metal is plated on a surface thereof.

3. The micro-filer as claimed in claim 1, wherein powder coating is performed on the surface of the micro-filer by means of using powder paint.

4. The micro-filer as claimed in claim 1, wherein powder coating is performed on the surface of the micro-filer by means of using powder paint.

5. The micro-filer as claimed in claim 1, wherein the micro-filer is in a spherical shape or an oval shape.

6. The micro-filer as claimed in claim 1, wherein the micro-filer is less than 50 μm in diameter.

7. An injection molding machine comprising:
metal molds in which micro-filers are distributed in resin and the cavity is formed to have the resin injected, thereby injection molding a product; and
a magnetic force generation unit for generating a magnetic force strong enough that the magnetic force is applied to the micro-filers distributed within the resin and the micro-filers are distributed concentratedly at one side of the injection molded product of resin.

8. The injection molding machine as claimed in claim 7, wherein an anti-rust metal is plated or a colored paint is painted on a surface of the micro-filer.

9. The injection molding machine as claimed in claim 7, wherein the micro-filer is less than 50 μm in diameter.

10. The injection molding machine as claimed in claim 7, wherein the micro-filer is in a spherical shape or an oval shape.

11. The injection molding machine as claimed in claim 7, wherein the magnetic force generated from the magnetic force generation unit is applied in a direction to pull the micro-filers toward an exterior surface of an injection molded product of resin.

12. A method of injection molding comprising:
a resin injection step in which resin having magnetic micro-filers distributed therein is injected;
a magnetization step in which a magnetic force is generated in one side direction of metal molds and applied to the micro-filers within the resin for concentratedly distributing the micro-filers on one side of the resin;
a cooling step in which the resin is cooled and hardened in the metal molds; and
an extraction step in which the hardened resin is extracted from the metal molds.

13. The injection molding method as claimed in claim 12, wherein an anti-rust metal is plated or a colored paint is painted on a surface of the micro-filer.

14. The injection molding method as claimed in claim 12, wherein the micro-filer is less than 50 μm in diameter.

15. The injection molding method as claimed in claim 12, wherein the micro-filer is in a spherical shape or an oval shape.
